(19) United States
(12) Patent Application Publication
(10) Pub. No.: US 2015/0287014 A1
(43) Pub. Date: Oct. 8, 2015

(54) MANAGING CHECK IN APPLICATIONS USING PROTOCOL HANDLERS

(71) Applicant: EBAY INC., San Jose, CA (US)

(72) Inventor: John Hastings Granbery, Los Altos, CA (US)

(21) Appl. No.: 14/248,278

(22) Filed: Apr. 8, 2014

(51) Int. Cl. G06Q 20/22; G06Q 20/32; G06Q 20/38

(52) U.S. Cl. CPC G06Q 20/227; G06Q 20/382; G06Q 20/3226

(57) ABSTRACT

Systems and methods are provided which allow for the management of check in applications installed on a user device using protocol handlers. In particular, the provided systems and methods allow a beacon to provide the user device with a protocol handler that may be registered with the user device to automatically process a check in with a particular check in application and deactivating other check in applications. Moreover, the provided systems and methods may allow a default check in application to be used to process the check in when the beacon does not provide a protocol handler or provides a protocol handler that is not registered with the user device.

### BACKGROUND

1. Technical Field

Embodiments disclosed herein are related to systems and methods for managing check ins when a device has multiple check in applications installed.

2. Related Art

Computer systems and networks have facilitated the tasks of buying, selling and transferring goods. For example, global computer networks, such as the Internet, have allowed purchasers to relatively quickly and efficiently seek and purchase goods online. Similarly, global computer networks provide an efficient and cost-effective medium for sellers to advertise, offer, provide, and sell their goods. Electronic commerce companies provide buyers and sellers with online services and the infrastructure to accept orders of goods from remote purchasers, to perform the financial transactions necessary to confirm and complete the sale of goods, to ship or distribute the goods to remote purchasers, and to perform other related logistics. Technology advances have also allowed for a wider variety of devices and transaction types in the retail and other marketplaces.

One example of a relatively new development within the realm of electronic commerce is the ability to allow a consumer to pay for a good or service at a point of sale through the use of his or her smart phone or other personal mobile device. A user merely needs to have an appropriate payment application or “app” on his or her device, whereupon the user can present his or her phone or other similar device at an appropriate time and location at a retail or other establishment. The retailer or other seller or service provider can then “check in” the given user through some process of reading his or her smart phone or other similar device, after which the seller or service provider can accept payment or credit through some form of communication with the checked in or acknowledged device. This “check in” ability to accept payment or credit without the use of cash, checks, credit cards, or other traditional payment means can be particularly helpful in many settings.

Unfortunately, such setups are not without their own drawbacks and inconvenient features. In many instances, the current check in process can be time consuming. For example, current check in procedures often require the customer to take out his or her phone or other device at a point of sale in order to make a payment or provide a credit. This often involves the device searching for the appropriate wireless connection at the store, searching for the store among many possible choices on the device, and/or manual user input or selection on his or her personal mobile device, all of which can take some inconvenient amount of time. Moreover, if a user device has multiple check in applications installed, the user may have to manually select and activate a particular application to perform the check in using that particular application.

### BRIEF DESCRIPTION OF THE FIGURES

FIG. 1 is a block diagram of a networked system, consistent with some embodiments.

FIG. 2 is a diagram illustrating a computing system, consistent with some embodiments.

FIG. 3 is a diagram illustrating a beacon, consistent with some embodiments.

FIG. 4 is a diagram illustrating a location having multiple beacons throughout the location.

FIG. 5 is a diagram illustrating a flow for checking in to a location when multiple check in applications may be installed on a device, consistent with some embodiments.

FIG. 6 is a flowchart illustrating a process for processing a check in to a location when multiple check in applications may be installed on a device, consistent with some embodiments.

In the drawings, elements having the same designation have the same or similar functions.

### DETAILED DESCRIPTION

In the following description specific details are set forth describing certain embodiments. It will be apparent, however, to one skilled in the art that the disclosed embodiments may be practiced without some or all of these specific details. The specific embodiments presented are meant to be illustrative, but not limiting. One skilled in the art may realize other material that, although not specifically described herein, is within the scope and spirit of this disclosure.

What is needed are systems and methods for managing multiple applications installed on a device capable of processing a check in, such that a preferred application processes the check in when possible, and a default application can process the check in when a preferred application is not available on a device.

Consistent with some embodiments, there is provided a system. The system includes one or more wireless transceivers configured to receive information using a Bluetooth® low energy (BLE) communications protocol. The system also includes one or more processors configured to determine when the information includes a protocol handler, process a check in at a location using a first check in application and deactivate a default check in application when an included protocol handler matches a protocol handler associated with the first check in application, process a check in at the location using the default check in application and deactivate the first check in application when the information does not include a protocol handler, includes a protocol handler associated with the default check in application, or includes a protocol handler that has not been registered on the system. The system also includes a memory configured to store instructions corresponding to the first check in application and the default check in application.

Consistent with some embodiments, there is further provided a method. The method includes steps of communicating with a beacon using Bluetooth® low energy (BLE) communications protocol to check in to a location, receiving information from the beacon, processing a check in using a first check in application and deactivating a default check in application when a protocol handler included in the received information is a first protocol handler, processing the check in using a default check in application when the received information does not include a protocol handler or includes a protocol handler that has not been registered with an operating system executed by the one or more processors, or includes a default protocol handler, and checking in at the location using the first check in application or default check in application. The method may be embodied in computer-readable media.

Embodiments described herein include a protocol handler that may be exchanged between a beacon and a device that may be registered with the operating system of the device for executing a particular check in application. The particular check in application may be an application specific to or provided by a particular location and the location may program beacons at the particular location to provide a protocol handler registered to the particular check in application such that the particular check in application processes the check in while other check in applications are deactivated and return to running in the background of the operating system of the client computing device when the beacon facilitated check in process occurs.

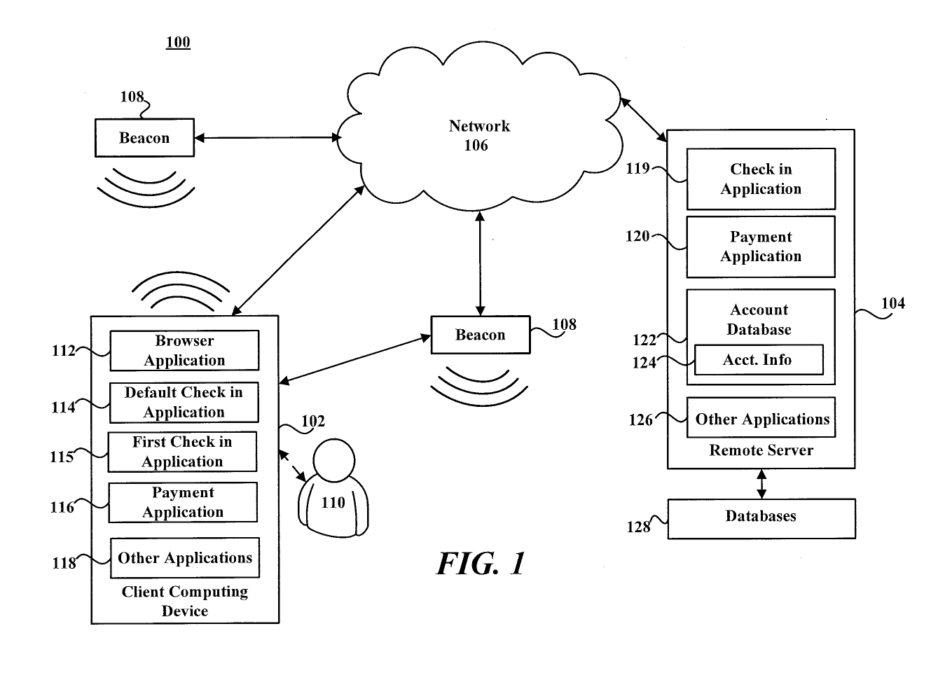

FIG. 1 is a block diagram of a networked system 100, consistent with some embodiments. System 100 includes a client computing device 102 and a remote server 104 in communication over a network 106. Remote server 104 may be a payment service provider server that may be maintained by a payment service provider, such as PayPal, Inc. of San Jose, Calif. Remote server 104 may be maintained by other service providers in different embodiments. Remote server 104 may also be maintained by an entity with which sensitive credentials and information may be exchanged with client computing device 102. Remote server 104 may further be one or more servers that hosts functionality for users to “check in” to a location, event, and the like. Checking in may provide the user that checks in with special offers, deals, and the like, and may let the merchant or other proprietor of the location or event that the user is there. The user may also check in to a location for social purposes to let friends and contacts of the user know that they have checked in. The user may also check in to a location to pay for items. Remote server 104 may be more generally a web site, an online content manager, a service provider, such as a bank, or other entity who provides content to a user requiring user authentication or login.

Network 106, in one embodiment, may be implemented as a single network or a combination of multiple networks. For example, in various embodiments, network 106 may include the Internet and/or one or more intranets, landline networks, wireless networks, and/or other appropriate types of communication networks. In another example, the network may comprise a wireless telecommunications network (e.g., cellular phone network) adapted to communicate with other communication networks, such as the Internet.

Client computing device 102, in one embodiment, may be implemented using any appropriate combination of hardware and/or software configured for wired and/or wireless communication over network 106. For example, client computing device 102 may be implemented as a wireless telephone (e.g., smart phone), tablet, personal digital assistant (PDA), notebook computer, personal computer, a connected set-top box (STB) such as provided by cable or satellite content providers, or a video game system console, a head-mounted display (HMD) or other wearable computing device, including a wearable computing device having an eyeglass projection screen, and/or various other generally known types of computing devices.

As shown in FIG. 1, system 100 may include one or more beacons 108. In some embodiments, beacons 108 may be installed at a merchant location, such as a store, restaurant, and the like. In some embodiments, beacons 108 may be Bluetooth™ Low Energy (BLE) beacons. BLE is a technology that transmits information at a frequency of about 2.4 GHz (about 2042-2480 MHz) over forty (40) 2-MHz wide channels, and has a range of about 50 meter or about 160 feet. Information transmitted according to the BLE protocol may be transmitted at a rate of about 1 Mbit/s with an application throughput of about 0.27 Mbit/s. In some embodiments, BLE communications may be secured using 128-bit Advanced Encryption Standard (AES) encryption with counter mode with a cipher block chaining message authentication code (CBC-MAC) and user defined security. Further, in some embodiments, BLE communications may utilize adaptive frequency hopping, lazy acknowledgement, a 24-bit cyclic redundancy check (CRC) and 32-bit message integrity check for robustness. Moreover, in some embodiments, BLE-capable devices may consume a fraction of the power of standard Bluetooth® devices due to the protocol allowing low duty cycles, and being designed for applications that may not require continuous data transfer. Beacons 108 may transmit one or more sequences of information such that when a device such as client computing device 102 capable of receiving information from beacons 108 comes within the range of a beacon 108, the device may receive a transmission from a beacon 108 and be instructed to perform an action, such as display an advertisement, execute a payment application, or activate a check in application to check a user 110 in to a particular location. In some embodiments, beacon 108 may be in communication with remote server 104 over network 106 through wireless or wired connection.

Client computing device 102 may include any appropriate combination of hardware and/or software having one or more processors and capable of reading instructions stored on a tangible non-transitory machine-readable medium for execution by the one or more processors. Consistent with some embodiments, client computing device 102 includes a machine-readable medium, such as a memory (not shown) that includes instructions for execution by one or more processors (not shown) for causing client computing device 102 to perform specific tasks. In some embodiments, the instructions may be executed by the one or more processors in response to interaction by user 110. For example, such instructions may include browser application 112 such as a mobile browser application, which may be used to provide a user interface to permit user 110 to browse information available over network 106, including information hosted by remote server 104. For example, browser application 112 may be implemented as a web browser to view information available over network 106. Browser application 112 may include a graphical user interface (GUI) that is configured to allow user 110 to interface and communicate with remote server 104 or other servers managed by content providers or merchants via network 106. For example, user 110 may be able to access websites to find and purchase items, as well as access user account information or web content.

Client computing device 102 may also include a default check in application 114 and a first check in application 115. Client computing device 102 may also have additional check in applications that are not shown in FIG. 1. In general, default check in application 114, first check in application 115, and other check in applications that may be on client computing device may allow user 110 to check in to a location using a check in platform or service such as may be provided by PayPal, Inc. of San Jose, Calif., Foursquare of New York, N.Y., Facebook, Inc., of Menlo Park, Calif., Google+ of Google, Inc. of Mountain View, Calif., or Yelp Inc. of San Francisco, Calif., and implemented by remote server 104. In some embodiments, check in application may include multiple application programming interfaces (APIs) for checking in to one or more of the check in platforms or services. According to some embodiments, default check in application 114 may be associated with a particular check in platform or service implemented by one remote server 104, and first check in application 115 may be associated with a different check in platform or service implemented by another remote server 104. In some embodiments, checking in to a location while visiting a location such as a merchant physical storefront may provide user with exclusive deals, offers, or may allow user to purchase and pay for items. Consequently, a location may want to be associated with a particular check in platform and/or application such that the location would prefer that user 110 check in to the location using the particular check in platform and/or application. For example, a location may have developed their own check in application with check in capabilities managed by a remote server 104 maintained by the location. While user 110 can check in to the location using either default check in application 114 or first check in application 115 (or other check in applications not shown), the location may prefer application 114 or application 115 because the preferred application may provide additional features, offers, content, and the like to user 110.

Client computing device 102 may also include a payment application 116 that may be used by user 110 using client computing device 102 to make a payment. In some embodiments, payment application 116 may be configured to make a payment using remote server 104 as a payment processor. In some embodiments, functionalities provided by default check in application 114 or first check in application 115 and payment application 116 may actually be provided by a single application. Client computing device 102 may include other applications 118 as may be desired in one or more embodiments to provide additional features available to user 110, including accessing a user account with remote server 104. For example, applications 118 may include interfaces and communication protocols that allow the user to receive and transmit information through network 106 and to remote server 104 and other online sites. Applications 118 may also include security applications for implementing client-side security features, programmatic client applications for interfacing with appropriate APIs over network 106 or various other types of generally known programs and/or applications. Applications 116 may include mobile applications downloaded and resident on client computing device 102 that enables user 110 to access content through the applications.

Remote server 104, according to some embodiments, may be maintained by an online payment provider, such as PayPal, Inc. of San Jose, Calif., which may provide processing for online financial and information transactions on behalf of user 110. Remote server 104, according to some embodiments, may also be maintained by a service that processes check ins so that a proprietor of a location, such as a merchant, or others know that user 110 is at the location and is able to provide content to user 110 as a result of the check in. Remote server 104 may also be capable of providing access to a merchant's goods and services (collectively referred to as “items”) that are for purchase and may provide a payment service processing for the purchased items. Remote server 104 may include at least check in application 119, which may be configured to interact with client computing device 102 connected to network and remote server 104 to check user 110 in to a location. In some embodiments, checking client computing device 102 in to a location may allow user 110 and client computing device 102, to access features, specials, offers, and the like offered by the location. In some embodiments, these features, specials, offers, and the like may be provided and processed by remote server 104 on behalf of the location. In some embodiments, check ins may be automatic check ins made through the communication of client computing device 102 and beacon 108, such as described in U.S. patent application Ser. No. 13/938,860, filed on Jul. 10, 2013, and U.S. patent application Ser. No. 14/021,045, filed on Sep. 9, 2013, the entire contents of both of these applications which are hereby incorporated by reference in their entirety.

Remote server 104 may also include a payment application 120 that may facilitate processing payments for user 110 to merchants, for example. In some embodiments, payment application 120 may be configured to interface with payment application 116 to receive payment details, user information, merchant information, and additional information for processing a payment on behalf of user 110. Payment application 120 may also be capable of interfacing with check in application 119 such that when a check in is processed a payment may be authorized for the location in which user 110 is checking in to. In some embodiments, functionalities provided by check in application 119 and payment application 120 may actually be provided by a single application. Remote server 104 may also include an account database 122 that includes account information 124 for users having an account on remote server 104, such as user 110. In some embodiments, payment application 120 may process payments based on information in account information 124 of account database 122. Remote server 104 may include other applications 126 and may also be in communication with one or more external databases 128, that may provide additional information that may be used by remote server 104. In some embodiments, databases 128 may be databases maintained by third parties, and may include third party account information of user 110.

As used herein, user 110 may have an account with remote server 104 such that account information 124 includes information about user 110. When user 110 checks in with remote server 104 or performs other authentication with remote server 104, client computing device 102 may be associated with user 110 such that remote server 104 recognizes client computing device 102 as being associated with user 110. In some embodiments, remote server 104 may send a cookie or other object to client computing device 102 that provides an indication of the association between user 110 and client computing device 102.

Although discussion has been made of applications and applications on client computing device 102 and remote server 104, the applications may also be, in some embodiments, modules. Module, as used herein, may refer to a software module that performs a function when executed by one or more processors or Application Specific Integrated Circuit (ASIC) or other circuit having memory and at least one processor for executing instructions to perform a function, such as the functions described as being performed by the applications.

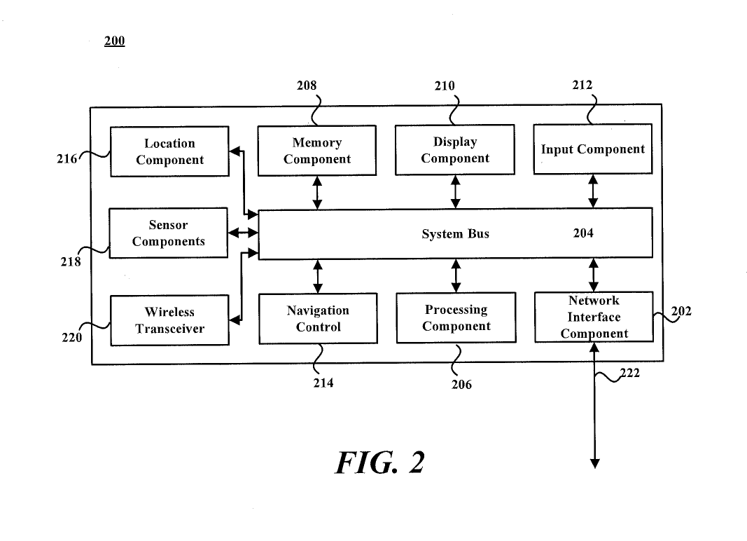

FIG. 2 is a diagram illustrating computing system 200, which may correspond to either of client computing device 102 or remote server 104, consistent with some embodiments. Computing system 200 may be a mobile device such as a smartphone, a tablet computer, a personal computer, laptop computer, netbook, or tablet computer, set-top box, video game console, head-mounted display (HMD) or other wearable computing device as would be consistent with client computing device 102. Further, computing system 200 may also be a server or one server amongst a plurality of servers, as would be consistent with remote server 104. As shown in FIG. 2, computing system 200 includes a network interface component (NIC) 202 configured for communication with a network such as network 108 shown in FIG. 1. Consistent with some embodiments, NIC 202 includes a wireless communication component, such as a wireless broadband component, a wireless satellite component, or various other types of wireless communication components including radio frequency (RF), microwave frequency (MWF), and/or infrared (IR) components configured for communication with network 106. Consistent with other embodiments, NIC 202 may be configured to interface with a coaxial cable, a fiber optic cable, a digital subscriber line (DSL) modem, a public switched telephone network (PSTN) modem, an Ethernet device, and/or various other types of wired and/or wireless network communication devices adapted for communication with network 106.

Consistent with some embodiments, computing system 200 includes a system bus 204 for interconnecting various components within computing system 200 and communicating information between the various components. Such components include a processing component 206, which may be one or more processors, micro-controllers, graphics processing units (GPUs) or digital signal processors (DSPs), and a memory component 208, which may correspond to a random access memory (RAM), an internal memory component, a read-only memory (ROM), or an external or static optical, magnetic, or solid-state memory. Consistent with some embodiments, computing system 200 further includes a display component 210 for displaying information to a user 120 of computing system 200. Display component 210 may be a liquid crystal display (LCD) screen, an organic light emitting diode (OLED) screen (including active matrix AMOLED screens), an LED screen, a plasma display, or a cathode ray tube (CRT) display. Computing system 200 may also include an input component 212, allowing for a user of computing system 200, such as consumer 120, to input information to computing system 200. Such information could include payment information such as an amount required to complete a transaction, account information, authentication information such as a credential, or identification information. An input component 212 may include, for example, a keyboard or key pad, whether physical or virtual. Computing system 200 may further include a navigation control component 214, configured to allow a user to navigate along display component 210. Consistent with some embodiments, navigation control component 214 may be a mouse, a trackball, or other such device. Moreover, if device 200 includes a touch screen, display component 210, input component 212, and navigation control 214 may be a single integrated component, such as a capacitive sensor-based touch screen.

Computing system 200 may further include a location component 216 for determining a location of computing system 200. In some embodiments, location component 216 may correspond to a GPS transceiver that is in communication with one or more GPS satellites. In other embodiments, location component 216 may be configured to determine a location of computing system 200 by using an internet protocol (IP) address lookup, or by triangulating a position based on nearby telecommunications towers or wireless access points (WAPs). Location component 216 may be further configured to store a user-defined location in memory component 208 that can be transmitted to a third party for the purpose of identifying a location of computing system 200. Computing system 200 may also include sensor components 218. Sensor components 218 provide sensor functionality, and may correspond to sensors built into client computing device 102 or sensor peripherals coupled to client computing device 102. Sensor components 218 may include any sensory device that captures information related to user 110 and/or client computing device 102 that may be associated with any actions that user 110 performs using client computing device 102. Sensor components 218 may include camera and imaging components, accelerometers, biometric readers, GPS devices, motion capture devices, and other devices that are capable of providing information about client computing device 102 or user 110, or an environment therearound. Computing system 200 may also include one or more wireless transceivers 220 that may each include an antenna that is separable or integral and is capable of transmitting and receiving information according to one or more wireless network protocols, such as Wi-Fi™, 3G, 4G, HSDPA, LTE, RF, NFC, IEEE 802.11a, b, g, n, ac, or ad, Bluetooth®, BLE, WiMAX, ZigBee®, etc.

Computing system 200 may perform specific operations by processing component 206 executing one or more sequences of instructions contained memory component 208. In other embodiments, hard-wired circuitry may be used in place of or in combination with software instructions to implement the present disclosure. Logic may be encoded in a computer readable medium, which may refer to any medium that participates in providing instructions to processing component 206 for execution, including memory component 208. Consistent with some embodiments, the computer readable medium is tangible and non-transitory. In various implementations, non-volatile media include optical or magnetic disks, volatile media includes dynamic memory, and transmission media includes coaxial cables, copper wire, and fiber optics, including wires that comprise system bus 204. Some common forms of computer readable media include, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, or any other medium from which a computer is adapted to read.

In various embodiments of the present disclosure, execution of instruction sequences to practice the present disclosure may be performed by computing system 200. In various other embodiments of the present disclosure, a plurality of computing systems 200 coupled by a communication link 222 to network 108 (e.g., such as a LAN, WLAN, PTSN, and/or various other wired or wireless networks, including telecommunications, mobile, and cellular phone networks) may perform instruction sequences to practice the present disclosure in coordination with one another. Computing system 200 may transmit and receive messages, data and one or more data packets, information and instructions, including one or more programs (i.e., application code) through communication link 222 and network interface component 202 and wireless transceiver 220. Received program code may be executed by processing component 206 as received and/or stored in memory component 208.

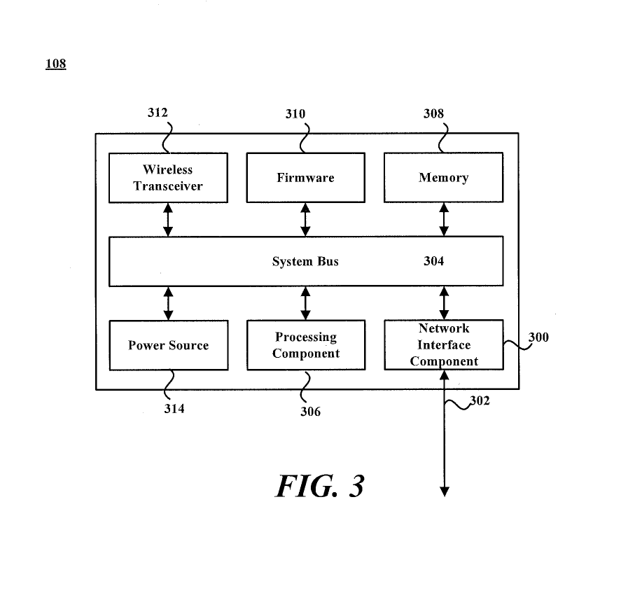

FIG. 3 is a diagram illustrating a beacon 108, consistent with some embodiments. As shown in FIG. 3, beacon 108 includes a network interface component (NIC) 300 configured for communication with a network such as network 106 shown in FIG. 1. Consistent with some embodiments, NIC 300 includes a wireless communication component, such as a wireless broadband component, a wireless satellite component, or various other types of wireless communication components including radio frequency (RF), microwave frequency (MWF), and/or infrared (IR) components configured for communication 302 with network 106. Consistent with other embodiments, NIC 300 may be configured to interface with a coaxial cable, a fiber optic cable, a digital subscriber line (DSL) modem, a public switched telephone network (PSTN) modem, an Ethernet device, and/or various other types of wired and/or wireless network communication devices adapted for communication with network 106.

Beacon 108 also includes a system bus 304 for interconnecting various components within beacon 108 and communicating information between the various components. Such components include a processing component 306, which may be one or more processors, micro-controllers, graphics processing units (GPUs) or digital signal processors (DSPs), a memory component 308, firmware 310 and one or more wireless transceivers 312 that may each include an antenna that is separable or integral and is capable of transmitting and receiving information according to one or more wireless network protocols, such as Wi-Fi™, 3G, 4G, HSDPA, LTE, RF, NFC, IEEE 802.11a, b, g, n, ac, or ad, Bluetooth®, BLE, WiMAX, ZigBee®, etc. In some embodiments, wireless transceivers 312 and network interface component 302 may be part of the same component, or may be separate components. In some embodiments, network interface component 302 and wireless transceivers 312 may be capable of communicating with a device based on instructions executed by processing component 306. In other embodiments, network interface component 302 and wireless transceivers 312 may include one or more processors capable of executing instructions for establishing communications and communicating information over an established communication. Beacon 108 may also include a power source 314. Power source 314 may be any power source capable of providing sufficient current to power the components of beacon 108. In some embodiments, power source 318 may be a battery, such as a watch battery or button cell.

In some embodiments, beacon 108 may be configured to transmit information using network interface component 302 and/or wireless transceivers 312 based on instructions stored in memory 308 and/or firmware 310 executed by processing component 306 or by one or more processors in network interface component 302 or wireless transceivers 312. The instructions may be stored in memory 308 and/or firmware 310 by directly writing the instructions to memory 308 and/or firmware 310 over communication link 302 to beacon hardware interface 300 or by wirelessly receiving instructions by wireless transceivers 312. In some embodiments, beacon 108 may be configured to transmit information related to checking in to a merchant associated with beacon 108. In some embodiments, beacon 108 may also transmit instructions that when received by client computing device 102 may cause default check in application 114, first check in application 115 or payment application 116 to be executed by processing component 206 to cause client computing device 102 to perform a check in at the merchant associated with beacon 108. Further, beacon 108 may transfer instructions that, when received by client computing device 102 cause payment application 116 to be executed by processing component to allow user 110 to authorize a payment to be processed by remote server 104. Beacon 108 may also send metadata to client computing device 102 that may include one or more protocol handlers that may be used to specify a particular check in application to be executed and activated. In some embodiments, wireless transceiver 312 may correspond to a BLE transceiver configured to transmit and receive information according to the BLE protocol. In some embodiments, beacon 108 may be a BLE beacon or dongle such as described in U.S. patent application Ser. No. 13/938,860, filed on Jul. 10, 2013, the entire contents of which are hereby incorporated by reference in their entirety. Further, BLE beacon 108 may have a design such as shown in U.S. Design application No. 29/455,720, filed May 23, 2013, the entire contents of which are also incorporated herein by reference in their entirety.

As will be readily appreciated, the foregoing networks, systems, devices, methods and variations thereof can be used to implement an automated check in of users at a cooperating or subscribing establishment, such that subsequent purchase transactions and other activities can be more streamlined and convenient.

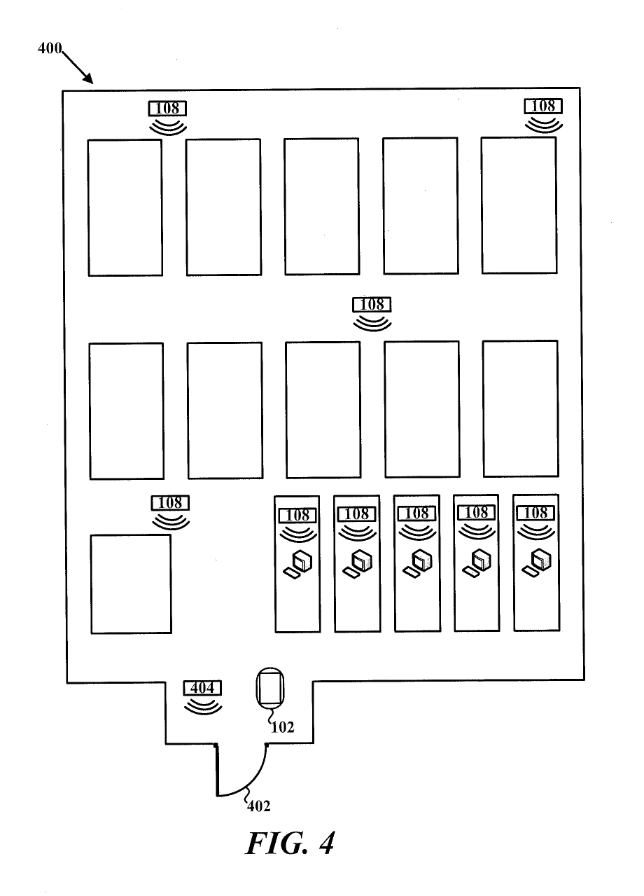

FIG. 4 illustrates in block diagram format an exemplary merchant location 400 and associated system components adapted for implementing the purchase of goods or services using automatic wireless consumer check ins according to some embodiments. It will be readily appreciated that this particular layout of merchant location 400 is only provided for purposes of illustration, and that many other types of layouts, devices, procedures and the like could be effectively implemented using the various principles of the present disclosure.

Merchant location 400 includes an indoor store floor having a number of beacons. In some embodiments, beacons 108 may be BLE beacons. These devices can be distributed strategically throughout merchant location, such as near the front door 402, at central locations, and/or at locations of high volume traffic within the establishment. One or more client computing devices 102 can interact with one or more of the beacons 108 throughout location 400. Preferably, only one interaction with a beacon 108 is needed for a check in, although it may be useful for an establishment to know where user 110 is located and/or where user 110 travels and shopping patterns or habits within location 400. Such further information can be used to provide further advertising and promotional offers (e.g., related to something at or near where the user is physically located), and/or to authenticate the actual user versus one who may have stolen or is otherwise using the mobile device in an unauthorized fashion. Such further authentication can involve checking known user 110 traffic and shopping patterns against what is currently happening for a given device 102.

An actual automatic check in process can involve a subscribed or affirmatively active user 110 entering a merchant location 400, whereupon client computing device 102 associated with user 110 has a low level background program such as default check in application 114 and/or first check in application 115 running that detects a low level BLE signal from one or more beacons 108 in the store. Client computing device 102 can then “wake up” and communicate on a more active level with beacon 108, which may include the activation of default check in application 114 and/or first check in application 115 being activated based on one or more protocol handlers that may be included in metadata sent to client computing device 102 by beacon 108. In some embodiments, a device identifier and token can be generated and assigned to client computing device 102 for a particular time, location and session, with appropriate expiration and other safeguards in place to protect against fraud or other misuse. For example, a period of one or two hours might suffice for a typical check in session or event. The process of establishing communications between client computing device 102 and beacon 108 and exchanging metadata and a one-time use beacon token to perform a check in is described in U.S. patent application Ser. No. 13/938,860, filed on Jul. 10, 2013, and U.S. patent application Ser. No. 14/021,045, filed on Sep. 9, 2013, the entire contents of both of these applications which are hereby incorporated by reference in their entirety.

When user 110 having client computing device 102 enters location 400, user 110 may complete the automatic check in facilitated by BLE beacon 108, as discussed above. In some embodiments, the check in may be performed between client computing device 102 and beacon 404 located near door 402 at an entrance to location 400. However, location 400 may have a particular location-specific check in application that, when used by user 110 to check in at location 400, may provide an ideal experience to user 110 while at location 400. When user 110 enters location 400 and receives information from a beacon, such as beacon 404, for checking in to location 400, beacon 404 or other beacons 108 are not aware if client computing device 102 has the particular location-specific application installed thereon. Moreover, if client computing device 102 has the location-specific application as well as other check in applications installed thereon, the proprietors of location 400 may prefer that client computing device 102 check in with the location-specific application and not the other applications. Furthermore, if client computing device 102 does not have the location-specific application installed thereon, the proprietors of location 400 may prefer that client computing device 102 use a default check in application to check in, wherein remote server 104 may still be able to provide content to user 110 through the default check in application or even provide user 110 with a link to the location-specific check in application. In some embodiments, when client computing device 102 communicates with beacon 108 to check in, all available check in applications may be activated and attempt to check in through beacon. As a result, issues can occur when location 400 or user 108 wants to only check in through a single check in application.

In some embodiments, beacon 108 (including beacon 404) may be configured to send a protocol handler that may be specific to a particular check in application, such as a location-specific application, to client computing device 102. In some embodiments, the protocol handler may be included in metadata sent by beacon 108, while in other embodiments, the protocol handler may be part of the information broadcast or advertised by beacon 108. Protocol handlers may be specific instructions that may be mapped to certain actions, applications, and the like, based on certain registrations within the operating system of client computing device 102. For example, http:// may be a protocol handler that is registered to browser application 112 such that when client computing device 102 receives that protocol handler, browser application 112 may be executed and activated. As another example, firstcheckin-beacon-<appid>:// may be a protocol handler that is registered to first check in application 115 such that when client computing device 102 receives the firstcheckin-beacon-<appid>:// protocol handler, first check in application 115 may be executed and activated, while other available check in applications, such as default check in application 114, are deactivated. In some embodiments, the protocol handlers corresponding to specific applications may be registered in the operating system when the applications are installed on client computing device 102. The protocol handlers may enable client computing device 102 to may have one or more protocol handlers registered in the operating system to one or more applications such that specific applications can be executed and activated upon receiving the protocol handler, while other applications are deactivated. Beacons 108 (and 404) may then be programmed to send a specific protocol handler to client computing device 102 as client computing device 102 communicates with beacon 108 to begin the check in process that, if registered, will execute and keep active the specific check in application associated with that protocol handler while non-associated check in applications are deactivated.

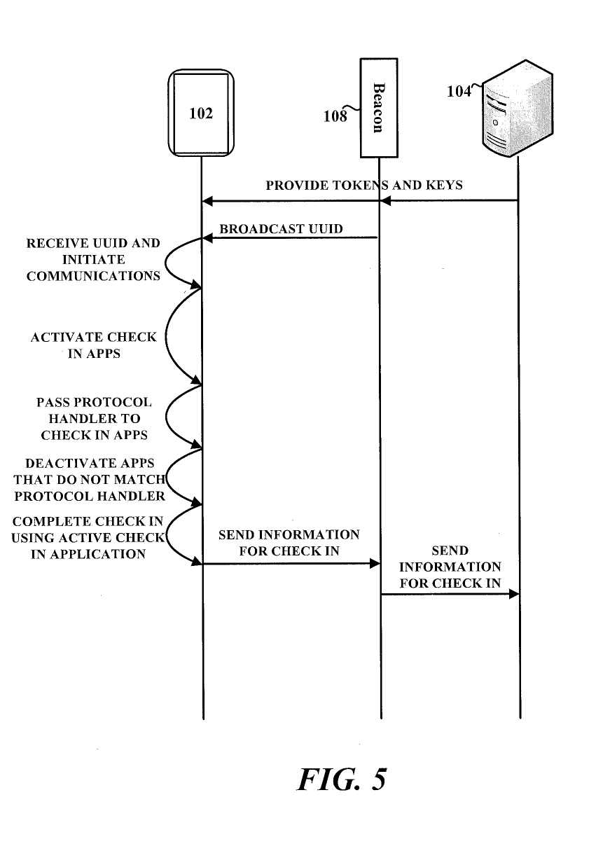

FIG. 5 is a diagram illustrating a flow for checking in to a location when multiple check in applications may be installed on client computing device 102, consistent with some embodiments. As shown in FIG. 5, remote server 104 may provide beacon 108 and client computing device 102 with tokens and keys. In some embodiments, the tokens and keys may be one-time use payment tokens and associated keys wherein the associated keys may include a pair of symmetric keys and the tokens can each have, for example, a user identifier, a token value, a key serial number and an AES or other crypto key. In some embodiments, remote server 104 may provide beacon with tokens and keys when beacon 108 is set up to work with remote server 104 for checking in users through remote server 104. Remote server 104 may further provide beacon 108 with digital signatures and merchant one-time use tokens that may be used to track check ins and transactions. In some embodiments, tokens and keys may be provided to client computing device 102 when user 110 using client computing device 102 signs up for a check in service provided by remote server 104 and/or when check in application 114 is installed on client computing device 102.

Beacon 108 may then continuously broadcast a generic identifier. In some embodiments, the identifier may be a universally unique identifier (UUID) and the identifier may be broadcast using a BLE communications protocol. Along with the broadcast identifier, beacon 108 may also broadcast a protocol handler for identifying a specific check in application. The identifier may be received by client computing device 102 to initiate communications with beacon 108. Applications installed on client computing device 102 and capable of communicating with beacon 108 for checking in to a location through beacon 108 may then be activated. When a protocol handler has been received by client computing device 102, the protocol handler may be passed to default check in application 114 and first check in application 115, or other check in applications. Check in applications that match the protocol handler or are otherwise associated with the protocol handler may continue to remain active and process the check in, while check in applications that do not match the protocol handler may be deactivated. For example, if the protocol handler is registered with the operating system of client computing device 102 to first check in application 115, first check in application 115 will remain activated, and default check in application 114 will be deactivated. Similarly, if the protocol handler is registered with the operating system of client computing device to a second check in application, that second check in application will be executed and remain active to process the check in and default check in application 114 and first check in application 115 will not be deactivated. In some embodiments, check in applications including default check in applications 114 and first check in application 115 may be executing in the background and may remain in the background when a protocol handler registered to another check in application is received. In some embodiments, if the metadata does not include a protocol handler, or includes a protocol handler that is not registered with the operating system of client computing device 102, which may be indicative that the preferred check in application associated with the protocol handler is not installed on client computing device 102, default check in application 114 may be capable of processing the check in.

The check in application that remains active may then be used to complete the check in. In some embodiments, the active check in application may provide user 110 with the option to check in. When user 110 accepts the check in, the activated check in application may be configured to verify received beacon information by using a public key received from remote server 104, and send information to beacon 104 for check in, which may include encrypted token values. Beacon 108 then sends the received information for check in to remote server 104 which checks in user 110 and client computing device 102 using the received information. The process of checking in by communicating with a BLE beacon, such as beacon 108, is further described in U.S. patent application Ser. No. 13/938,860, filed on Jul. 10, 2013, and U.S. patent application Ser. No. 14/021,045, filed on Sep. 9, 2013, the entire contents of both of these applications which are hereby incorporated by reference in their entirety.

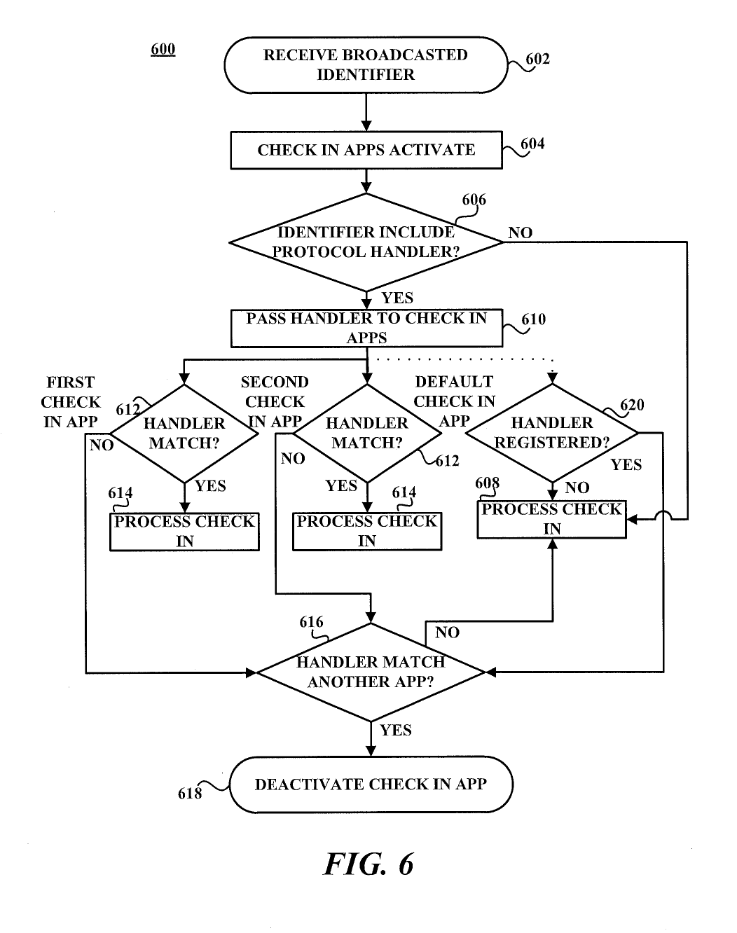

FIG. 6 is a flowchart illustrating a process for processing a check in to a location when multiple check in applications may be installed on client computing device 102, consistent with some embodiments. For the purpose of illustration, FIG. 6 may be described with reference to any of FIGS. 1-5. Process 600 shown in FIG. 6 may be embodied in computer-readable instructions for execution by one or more processors such that one or more of the steps of the method may be performed by processing component 206 of client computing device 102. As shown in FIG. 6, process 600 may begin when client computing device 102 receives a broadcasted identifier (602). The broadcasted identifier may be a UUID received from one or more beacons 108 in a location 400. In some embodiments, beacons 108 may be BLE beacons such that the identifier may be broadcast according to BLE communications protocols. In some embodiments, a protocol handler may be included with the broadcasted identifier. Client computing device 102 may include wireless transceiver 220 that may be capable of communicating with a beacon 108 using BLE communication protocols and receiving the broadcasted identifier.

Check in applications installed on client computing device 102, including default check in application 114 and first check in application 115 (604). In some embodiments, check in applications installed on client computing device 102 may be running in the background of the operating system looking for a beacon identifier and activate when an identifier is received in order to attempt to check in to a location through beacon 108.

In some embodiments, a protocol handler may also be received by client computing device 102 (606). Protocol handlers may be specific instructions that may be mapped to certain actions, applications, and the like, based on certain registrations within the operating system of client computing device 102. The protocol handler may be received along with the identifier or with metadata or other information received from beacon 108. When the metadata does not include a protocol handler, default check in application 114 may process the check in (608). In some embodiments, processing the check in may include default check in application 114 verifying information received from beacon 108 and prompting user 110 to accept the check in to location 400 by, for example, displaying an interactive prompt on display component 210. User 110 may be able to accept the check in by interacting with the prompt using input component 212, navigation control, and display component 210, or a combination thereof. When the check in is accepted, processing component 206 of client computing device 102 may then send check in information to beacon 108. In some embodiments, the check in information sent by client computing device may include encrypted token values and may be sent to beacon 108 by wireless transceiver 220 of client computing device 102 using a BLE communication protocol, and the encrypted values may then be sent to remote server 104 where check in application 119 may process the check in and check user 110 in at location 400.

When the metadata received from beacon 108 includes a protocol handler, the protocol handler may be passed, sent and otherwise provided to check in applications installed on client computing device 102 (610), which may include default check in application 114 and first check in application 115. In some embodiments, the protocol handler may be sent to the check in applications in accordance with instructions executed by processing component 206, and may be sent using interprocess communications handled by the operating system of client computing device 102. Once the check in applications receive the protocol handler, if the protocol handler matches a protocol handler registered to the check in application in the operating system (612), the matching check in application may then process the check in (614) similar to the process performed by default check in application 114 described previously. If the protocol handler does not match a protocol handler registered to the check in application in the operating system (612), but the protocol handler matches another check in application 616, the non-matching check in application may be deactivated (618). In some embodiments, multiple check in applications that do not match or correspond to the protocol handler may be deactivated and return to running in the background of the operating system. As shown in FIG. 6, steps 612-614 may be performed for first check in application 114 and other check in applications that may be installed on client computing device 102.

When default check in application 114 receives the protocol handler, default check in application may be deactivated (618) when the protocol handler is registered (620) and matches another check in application (616). In such instances, the logic of default check in application will be that the check in application associated with the registered protocol handler will be processing the check in. In some embodiments, default check in application may be running in the background of the operating system, activate when the beacon identifier is received, and return to a background or deactivated state when the protocol handler is registered. However, if the protocol handler is not registered, default check in application may process the check in (608) as described above. In such instances, the logic of default check in application 114 will be that when the received protocol handler is not registered in the operating system of client computing device 102, the corresponding check in application has not been installed on client computing device 102. In some embodiments, when the received protocol handler has not been registered, default check in application may provide a link to the corresponding check in application for user 110 to download and install on client computing device 102.

Software, in accordance with the present disclosure, such as program code and/or data, may be stored on one or more machine-readable mediums, including non-transitory machine-readable medium. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

Embodiments described herein include a protocol handler that may be exchanged between a beacon and a device that may be registered with the operating system of the device for executing a particular check in application. The particular check in application may be an application specific to or provided by a particular location and the location may program beacons at the particular location to provide a protocol handler registered to the particular check in application such that the particular check in application processes the check in while other check in applications are deactivated and return to running in the background of the operating system of the client computing device when the beacon facilitated check in process occurs. The examples provided above are exemplary only and are not intended to be limiting. One skilled in the art may readily devise other systems consistent with the disclosed embodiments which are intended to be within the scope of this disclosure. As such, the application is limited only by the following claims.

What is claimed is:

1. A system comprising:
one or more wireless transceivers configured to receive information using a Bluetooth® low energy (BLE) communications protocol;
one or more processors configured to:
determine when the information includes a protocol handler;
process a check in at a location using a first check in application and deactivate a default check in application when an included protocol handler matches a protocol handler associated with the first check in application;
process a check in at the location using the default check in application and deactivate the first check in application when the information does not include a protocol handler, includes a protocol handler associated with the default check in application, or includes a protocol handler that has not been registered on the system; and
a memory configured to store instructions corresponding to the first check in application and the default check in application.

2. The system of claim 1, wherein the one or more wireless transceivers are further configured to receive a broadcast identifier.

3. The system of claim 2, wherein the one or more wireless transceivers are further configured to receive the information from a beacon in communications with the system over the BLE communications protocol.

4. The system of claim 3, wherein:
the one or more processors are further configured to
verify beacon information; and
encrypt token values; and
the one or more wireless transceivers are further configured to send the encrypted token values to the beacon.

5. The system of claim 1, wherein the one or more processors are further configured to:
process the check in at the location using a second check in application and deactivate the first check in application and the default check in application when an included protocol handler matches a protocol handler associated with the second check in application.

6. The system of claim 1, further comprising a display component configured to display the first check in application or default check in application to a user of the system.

7. A computer-readable medium including instructions that, when executed by one or more processors, cause the one or more processors to perform a method comprising:
communicating with a beacon using Bluetooth® low energy (BLE) communications protocol to check in to a location;
receiving information from the beacon;
processing a check in using a first check in application and deactivating a default check in application when a protocol handler included in the received information is a first protocol handler;
processing the check in using a default check in application when the received information does not include a protocol handler or includes a protocol handler that has not been registered with an operating system executed by the one or more processors, or includes a default protocol handler; and
checking in at the location using the first check in application or default check in application.

8. The computer-readable medium of claim 7, wherein receiving information from the beacon comprises:
receiving a broadcast identifier from the beacon;
receiving secure beacon information; and
verifying the received secure beacon information.

9. The computer-readable medium of claim 8, wherein checking in at the location comprises:
encrypting check in information; and
sending the encrypted check in information to the beacon, the encrypted check in information configured for sending to a remote server associated with the first check in application or the default check in application.

10. The computer-readable medium of claim 7, further comprising:
processing the check in using a second check in application when an included protocol handler matches protocol handler associated with the second check in application and deactivating the first check in application and the default check in application; and
checking in at the location using the second check in application.

11. The computer-readable medium of claim 10, further comprising providing the included protocol handler to the first check in application, the second check in application, and the default check in application when the information includes a protocol handler.

12. The computer-readable medium of claim 7, wherein processing the check in using the first check in application comprises executing instructions stored in the computer-readable medium and registered in the operating system to the first protocol handler.

13. The computer-readable medium of claim 7, wherein processing the check in using the default check in application comprises executing instructions stored in the computer-readable medium not registered in the operating system to a protocol handler.

14. A method for checking in at a location, comprising:
communicating, by one or more wireless transceivers of a user device, with a beacon using Bluetooth® low energy (BLE) communications protocol to check in to the location;
receiving, by the one or more wireless transceivers, information from the beacon;
processing, by one or more processors of the user device, a check in using a first check in application and deactivating a default check in application when a protocol handler in the received metadata is a first protocol handler;
processing, by the one or more processors, the check in using the default check in application when the received metadata does not include a protocol handler, includes a protocol handler associated with the default checking application, or includes a protocol handler that has not been registered with an operating system executed by the one or more processors; and
checking in, by the one or more processors, at the location using the first check in application or default check in application.

15. The method of claim 14, wherein receiving information from the beacon comprises:
receiving a broadcast identifier from the beacon;
receiving secure beacon information; and
verifying the received secure beacon information.

16. The method of claim 15, wherein checking in at the location comprises:
encrypting check in information; and
sending the encrypted check in information to the beacon, the encrypted check in information configured for sending to a remote server associated with the first check in application or the default check in application.

17. The method of claim 14, further comprising:
processing the check in using a second check in application when an included protocol handler matches protocol handler associated with the second check in application and deactivating the first check in application and the default check in application; and
checking in at the location using the second check in application.

18. The method of claim 17, further comprising providing the included protocol handler to the first check in application, the second check in application, and the default check in application when the information includes a protocol handler.

19. The method of claim 14, wherein processing the check in using the first check in application comprises executing instructions stored in the computer-readable medium and registered in the operating system to the first protocol handler.

20. The method of claim 14, wherein processing the check in using the default check in application comprises executing instructions stored in the computer-readable medium not registered in the operating system to a protocol handler.
